(19) United States
(12) Patent Application Publication
(10) Pub. No.: US 2025/0133628 A1
(43) Pub. Date: Apr. 24, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/682,307

(22) PCT Filed: Aug. 10, 2021
(86) PCT No.: PCT/CN2021/111755

§ 371 Date: Feb. 8, 2024

(51) Int. Cl. H04W 76/34; H04W 8/18; H04W 76/38

(52) U.S. Cl. CPC H04W 76/34; H04W 8/18; H04W 76/38

(57) ABSTRACT

Embodiments of the present disclosure relate to methods, devices and computer readable media of communication. A terminal device in a connected state with a first network device determines that a connection is to be established with a second network device, and transmits, to the first network device, an indication that a portion of capability of the terminal device for a first subscriber identity module is to be released for simultaneous connections with the first and second network devices. Thereby, partial capabilities of the terminal device for the first subscriber identity module are released so that the terminal device has spare capabilities for a second subscriber identity module.

### TECHNICAL FIELD

Embodiments of the present disclosure generally relate to the field of telecommunication, and in particular, to methods, devices and computer storage media of communication in networks of multi-universal subscriber identity module (USIM).

### BACKGROUND

Currently, a multi-USIM terminal device occupies a large market share. Two USIMs may conform to same or different communication standards such as long term evolution (LTE), new radio (NR) or the like. A multi-USIM terminal device of Dual transmit (Tx))/Dual receive (Rx) (2Tx/2Rx) is capable to simultaneously receive traffic from two networks of USIMs or simultaneously transmit traffic to the two networks. Thus, in some scenarios, the multi-USIM terminal device may simultaneously establish connections in the two networks. However, solutions in NR Release 17 are not suitable for these scenarios, and thus enhancements on the solutions need to be studied for these scenarios.

### SUMMARY

In general, embodiments of the present disclosure provide methods, devices and computer storage media for communication in networks of multi-USIM.

In a first aspect, there is provided a method of communication. The method comprises: determining, at a terminal device in a connected state with a first network device, whether a connection is to be established with a second network device, the first network device being associated with a first subscriber identity module of the terminal device and the second network device being associated with a second subscriber identity module of the terminal device; and in accordance with a determination that the connection is to be established with the second network device, transmitting, to the first network device, an indication that a portion of capability of the terminal device for the first subscriber identity module is to be released for simultaneous connections with the first and second network devices.

In a second aspect, there is provided a method of communication. The method comprises: determining, at a terminal device, whether simultaneous connections are established with a first network device and a second network device, the first network device being associated with a first subscriber identity module of the terminal device and the second network device being associated with a second subscriber identity module of the terminal device; and in accordance with a determination that the simultaneous connections are established, transmitting, to the first network device, a first indication indicating the simultaneous connections.

In a third aspect, there is provided a method of communication. The method comprises: receiving, at a first network device and from a terminal device, an indication that a portion of capability of the terminal device for a first subscriber identity module of the terminal device is to be released for simultaneous connections with the first network device and a second network device, the first network device being associated with the first subscriber identity module of the terminal device and the second network device being associated with a second subscriber identity module of the terminal device.

In a fourth aspect, there is provided a method of communication. The method comprises: receiving, at a first network device and from a terminal device, a first indication indicating simultaneous connections of the terminal device with a first network device and a second network device, the first network device being associated with a first subscriber identity module of the terminal device and the second network device being associated with a second subscriber identity module of the terminal device.

In a fifth aspect, there is provided a terminal device. The terminal device comprises a processor and a memory coupled to the processor. The memory stores instructions that when executed by the processor, cause the terminal device to perform the method according to at least one of the first or second aspect of the present disclosure.

In a sixth aspect, there is provided a network device. The network device comprises a processor and a memory coupled to the processor. The memory stores instructions that when executed by the processor, cause the network device to perform the method according to the third or fourth aspect of the present disclosure.

In a seventh aspect, there is provided a computer readable medium having instructions stored thereon. The instructions, when executed on at least one processor, cause the at least one processor to perform the method according to at least one of the first or second aspect of the present disclosure.

In an eighth aspect, there is provided a computer readable medium having instructions stored thereon. The instructions, when executed on at least one processor, cause the at least one processor to perform the method according to the third or fourth aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication scenario in which some embodiments of the present disclosure can be implemented;

FIG. 1B illustrates a schematic diagram illustrating an example component of a network device in the example communication network;

FIG. 2 illustrates a schematic diagram illustrating a process for communication in networks of multi-USIM according to some embodiments of the present disclosure;

FIG. 3 illustrates a schematic diagram illustrating another process for communication in networks of multi-USIM according to some embodiments of the present disclosure;

FIG. 4 illustrates a schematic diagram illustrating another process for communication in networks of multi-USIM according to some embodiments of the present disclosure;

FIG. 5 illustrates a schematic diagram illustrating another process for communication in networks of multi-USIM according to some embodiments of the present disclosure;

FIG. 6 illustrates a schematic diagram illustrating another process for communication in networks of multi-USIM according to some embodiments of the present disclosure;

FIG. 7 illustrates a schematic diagram illustrating another process for communication in networks of multi-USIM according to some embodiments of the present disclosure;

FIG. 8 illustrates an example method of communication implemented at a terminal device in accordance with some embodiments of the present disclosure;

FIG. 9 illustrates another example method of communication implemented at a terminal device in accordance with some embodiments of the present disclosure;

FIG. 10 illustrates an example method of communication implemented at a network device in accordance with some embodiments of the present disclosure;

FIG. 11 illustrates another example method of communication implemented at a network device in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below:

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and play back appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below:

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

As used herein, the term “subscriber identity module (SIM)” refers to a universal subscriber identity module used in a terminal device. Examples of the SIM include, but not limited to, SIM card, USIM card, ISIM card, or the like. The term “SIM” can be used interchangeably with a USIM or ISIM.

In the context of the present disclosure, capability of a terminal device may be Single Tx/Single Rx (1Tx/1Rx), Single Tx/Dual Rx (1Tx/2Rx), Dual Tx/Single Rx (2Tx/1Rx), 2Tx/2Rx or the like. Single Tx (1Tx) allows the terminal device to transmit traffic to one of two networks of USIMs at one time. Single Rx (1Rx) allows the terminal device to receive traffic from one of two networks of two USIMs at one time. Dual Rx (2Rx) allows the terminal device to simultaneously receive traffic from two networks of two USIMs. Dual Tx (2Tx) allows the terminal device to simultaneously transmit traffic to two networks of two USIMs. The terms Single Rx/Tx and Dual Rx/Tx do not refer to a device type, bur refer to a capability of a device. A single terminal device may, as an example, uses Dual Tx for communication in some cases, but uses Single Tx for communication in some cases. Similarly, a single terminal device may, as an example, uses Dual Rx for communication in some cases, but uses Single Rx for communication in some cases. Of course, a single terminal device may; as an example, uses both Dual Rx and Dual Tx for communication in some cases.

Assuming that a terminal device supports both network A of USIM A and network B of USIM B. In some scenarios, the terminal device may have established a connection in the network A of USIM A using its full Rx/Tx capabilities and stay in an idle or inactive state in the network B of USIM B. In this case, if the terminal device needs to handle an incoming service from the network B, the terminal device expects to also establish a connection with the network B.

In view of this, one aspect of embodiments of the present disclosure provides a solution for capability coordination upon network switching. In the solution, an indication indicating reduction of capabilities of the terminal device for simultaneous connections is transmitted from the terminal device to the network A. In this way, the network A may release partial Rx/Tx capabilities such that the terminal device will have spare capabilities for the network B.

In some scenarios, the terminal device may have established a connection in the network A of USIM A and also have established a connection in the network B of USIM B, i.e., the terminal device may have established simultaneous connections with the networks A and B. In this case, one of the networks A and B may reconfigure the terminal device, which makes the simultaneous connections impossible as the simultaneous connections will cause some issues due to the reconfiguration. For example, interference between a cell of the network A and a cell of the network B will occur. As another example, configuration from the networks A and B may exceed the capability (for example, Rx/Tx capability) of the terminal device.

In view of this, another aspect of embodiments of the present disclosure provides a solution of handling the potential issues under the simultaneous connections. In this way, the behavior of the terminal device during the simultaneous connections can be specified.

Principles and implementations of the present disclosure will be described in detail below with reference to the figures.

### Example of Communication Network

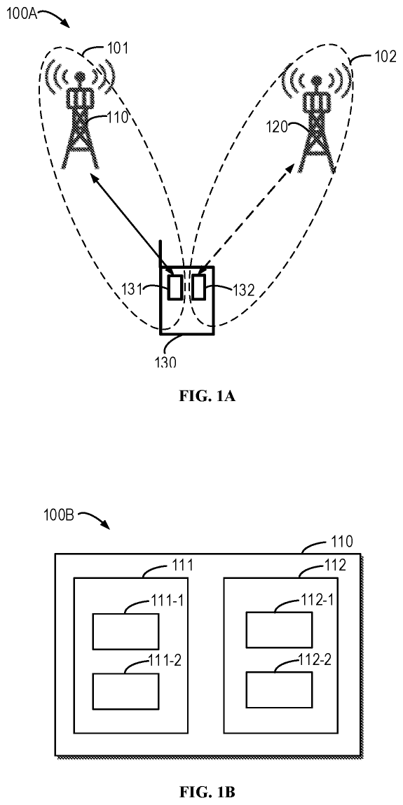

FIG. 1A illustrates a schematic diagram of an example communication scenario 100A in which embodiments of the present disclosure can be implemented. As shown in FIG. 1A, the communication scenario 100A may involve a first communication network 101 comprising a first network device 110 and a second communication network 102 comprising a second network device 120. It is to be understood that the first network device 110 is merely an example of network devices in the first communication network 101, and in fact, the first communication network 101 may further comprise more network devices. Similarly, the second network device 120 is merely an example of network devices in the second communication network 102, and in fact, the second communication network 102 may further comprise more network devices.

The communication scenario 100A may also involve a terminal device 130 carrying a first USIM 131 and a second USIM 132. The first USIM 131 communicates with external environment via the first communication network 101, and the second USIM 132 communicates with external environment via the second communication network 102. That is, the first USIM 131 is served by network devices in the first communication network 101, and the second USIM 132 is served by network devices in the second communication network 102.

The first and second USIMs 131 and 132 may conform same or different RATs which are existing now or to be developed in the future. That is, the first and second communication networks 101 and 102 may conform same or different RATs. It should be noted that the number of the USIMs carried by the terminal device 130 is not limited to two, and more than two USIMs also can be applied. Accordingly, it is also to be noted that the communication scenario 100A may involve more communication networks serving the USIMs. For convenience, the following description is given by taking two USIMs and two corresponding communication networks as an example.

It is to be understood that the first network device 110 may also support the second communication network 102, and the second network device 120 may also support the first communication network 101. Thus, the first network device 110 may serve at least one of the first and second USIMs 131 and 132. The second network device 120 may also serve at least one of the first and second USIMs 131 and 132. For convenience, unless otherwise stated, the following description is made under the assumption that the first network device 110 serves the first USIM 131 and the second network device 120 serves the second USIM 132. However, it should be noted that, it is merely an example for illustration, and does not make limitation for the present disclosure. For example, the first and second USIMs 131 and 132 may be served by the same network device such as the first network device 110 or the second network device 120.

The first network device 110 may communicate with the terminal device 130 via a channel such as a wireless communication channel. Similarly, the second network device 120 may also communicate with the terminal device 130 via a channel such as a wireless communication channel. In some embodiments where the first network device 110 supports the first communication network 101 and the second network device 120 supports the second communication network 102, the first USIM 131 may communicate with the first network device 110, and the second USIM 132 may communicate with the second network device 120. In some embodiments where the first network device 110 supports the second communication network 102 and the second network device 120 supports the first communication network 101, the first USIM 131 may communicate with the second network device 120, and the second USIM 132 may communicate with the first network device 110. In some embodiments where the first network device 110 supports both the first and second communication network 101 and 102, both the first USIM 131 and the second USIM 132 may communicate with the first network device 110. In some embodiments where the second network device 120 supports both the first and second communication network 101 and 102, both the first USIM 131 and the second USIM 132 may communicate with the second network device 120.

It is to be understood that the number of devices in FIG. 1A is given for the purpose of illustration without suggesting any limitations to the present disclosure. The communication scenario 100A may include any suitable number of network devices and/or terminal devices adapted for implementing implementations of the present disclosure.

The communications in the communication scenario 100A may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

FIG. 1B illustrates a schematic diagram 100B illustrating an example component of a network device in the example communication scenario 100A. For illustration, FIG. 1B will be described in connection with the first network devices 110. It is to be understood that the description on FIG. 1B also apply to other network devices in the communication scenario 100A that shown or not shown. As shown in FIG. 1B, the first network device 110 may comprise a master node (MN) 111 and a secondary node (SN) 112. It is to be understood that the MN 111 and the SN 112 may be implemented as network devices. The MN 111 may have serving cells 111-1 and 111-2, and the SN 112 may have serving cells 112-1 and 112-2. The group of serving cells associated with MN 111 (i.e. master cell group, MCG) may comprise a primary cell (PCell) and at least one secondary cell (SCell), and the group of serving cells associated with the SN 112 (i.e. secondary cell group, SCG) may comprise a primary secondary cell (PSCell) and at least one secondary cell (SCell). It is to be understood that each of the MCG and SCG may have more or less serving cells, and is not limited to that shown.

Return to FIG. 1A, in some scenarios, the terminal device 130 may have established a connection between the first USIM 131 and the first network device 110, and stay in an idle state or in an inactive state between the second USIM 132 and the second network device 120. In this case, when the terminal device 130 is to perform transmission or reception between the second USIM 132 and the second network device 120, the terminal device 130 may expect to establish a connection with the second network device 120.

In some scenarios, the terminal device 130 may have established a connection between the first USIM 131 and the first network device 110, and also have established a connection between the second USIM 132 and the second network device 120. That is, the terminal device 130 may have established simultaneous connections with networks of the first USIM 131 and the second USIM 132. In this case, the terminal device 130 may receive, from the first network device 110 or the second network device 120, a message for radio resource control (RRC) reconfiguration.

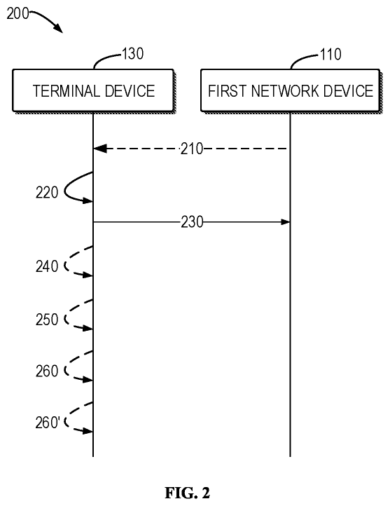

Embodiments of the present disclosure provide improved solutions for the above scenarios. It should be noted that the above scenarios are merely for illustration, and do not make limitation for the present disclosure. Solutions according to embodiments of the present disclosure can apply to any suitable scenarios. For convenience, these solutions will be described in details with reference to FIGS. 2 to 7.

### Example Implementation of Establishing Simultaneous Connections

FIG. 2 shows a schematic diagram illustrating a process 200 for communication in networks of multi-USIM according to embodiments of the present disclosure. For the purpose of discussion, the process 200 will be described with reference to FIG. 1. The process 200 may involve the terminal device 130 and the first network device 110 as illustrated in FIG. 1. Assuming that the terminal device 130 establishes a connection between the first USIM 131 and the first network device 110, and stays in an idle state or in an inactive state between the second USIM 132 and the second network device 120.

As shown in FIG. 2, the first network device 110 may transmit 210, to the terminal device 130, a configuration indicating transmission of an indication, the indication indicating that a portion of capability of the terminal device 130 for the first USIM 131 is to be released for simultaneous connections with the first and second network devices 110 and 120. In other words, the first network device 110 may configure the terminal device 130 to indicate the need to reduce capabilities of the terminal device 130 due to simultaneous connections.

In some embodiments, the first network device 110 may transmit the configuration in a RRC message. In some embodiments, the first network device 110 may transmit the configuration in system information. Of course, the first network device 110 may transmit the configuration in any other suitable ways.

The terminal device 130 determines 220 whether a connection is to be established with the second network device 120. For example, when the terminal device 130 needs to handle an incoming service from the second network device 120, the terminal device 130 may determine that the connection is to be established with the second network device 120.

If determining that the connection is to be established with the second network device 120, the terminal device 130 transmits 230, to the first network device 110, the indication that a portion of capability of the terminal device 130 for the first USIM 131 is to be released for simultaneous connections with the first and second network devices 110 and 120. In this way, capability coordination may be achieved for the simultaneous connections.

In some embodiments, the terminal device 130 may transmit, to the first network device 110, a RRC message comprising the indication. For example, the terminal device 130 may transmit a RRC message such as UEAssistanceInformation message to indicate the need to change its configuration to reduce partial capabilities of the terminal device 130 used at the first USIM 131 for purpose of the simultaneous connections. Of course, this is merely an example, and the indication may also be delivered in any other suitable ways.

In some embodiments, the indication may comprise information indicating a suggested configuration. In some embodiments, the suggested configuration may comprise at least one of the following: a request for deactivating a SCG of the terminal device 130 (also referred to as SCG deactivated request herein), a request for releasing a SCG of the terminal device 130 (also referred to as SCG release request herein), a set of Scells to be deactivated, a set of Scells to be released, or the maximum multi-input multi-output (MIMO) layer to be reduced.

In some embodiments, the indication may comprise information indicating a cause of the releasing being for the simultaneous connections. In other words, the cause of the capability reduction or configuration change is due to multi-USIM transmission.

In some embodiments, the indication may comprise information indicating a preferred RRC state at the first network device 110. For example, the indication may comprise information indicating RRC connected state or the like.

In some embodiments, the indication may comprise information indicating an expected time length for the releasing. In other words, the indication may comprise information indicating an expected time length for the capability reduction.

Upon the transmission of the indication, the terminal device 130 may start 240 a timer. In some embodiments, the terminal device 130 is forbidden to transmit 250 a further indication to the first network device 110 for the simultaneous connections during running of the timer. That is, if the timer is running, the terminal device 110 is not allowed to transmit another message for the same purpose. In this way, signaling overhead may be efficiently saved.

In some embodiments, if the timer is expired and no response for the releasing is received from the first network device 110, the terminal device 130 may release 260 the portion of the capability of the terminal device 130. That is, the terminal device 130 may reduce its capabilities at the first USIM 131 itself. In some alternative embodiments, if the timer is expired and no response for the releasing is received from the first network device 110, the terminal device 130 may enter 260′ (or go to) an idle state in the network of the first network device 110.

With the process described in connection with FIG. 2, capability coordination may be achieved for simultaneous connections of multi-USIM.

### Example Implementation of Handling Issues During Simultaneous Connections

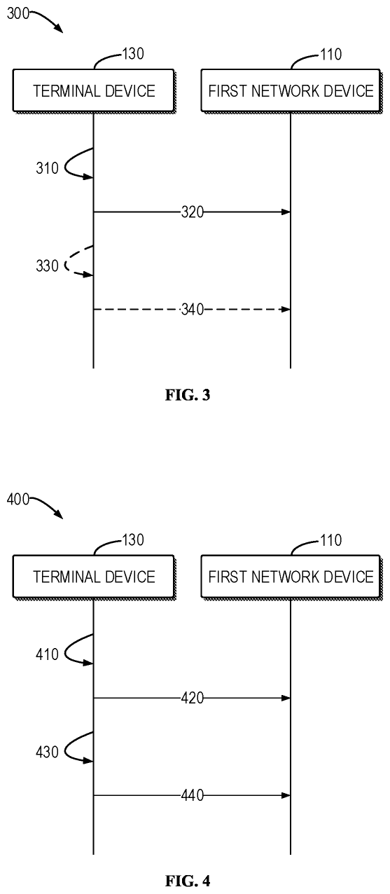

As mentioned above, a terminal device may be reconfigured during simultaneous connections for multi-USIM of the terminal device. Embodiments of the present disclosure provide solutions for handling issues caused by the simultaneous connections in this case. This will be described in detail with reference to FIG. 3. FIG. 3 illustrates a schematic diagram illustrating another process 300 for communication according to embodiments of the present disclosure. For the purpose of discussion, the process 300 will be described with reference to FIG. 1. Assuming that the terminal device 130 has established simultaneous connections with the first network device 110 and the second network device 120. The process 300 may involve the terminal device 130 and the first network device 110 (also referred to as a network device here) as illustrated in FIG. 1.

As shown in FIG. 3, the terminal device 130 determines 310 whether simultaneous connections are established with the first network device 110 and the second network device 120. For example, when the terminal device 130 determines that a RRC connection is established between the first USIM 131 and the first network device 110 and that a RRC connection is established between the second USIM 132 and the second network device 120, the terminal device 130 may determine that the simultaneous connections are established with the first network device 110 and the second network device 120.

If determining that the simultaneous connections are established, the terminal device 130 transmits 320, to the first network device 110, a first indication indicating the simultaneous connections. It is to be understood that the first indication may be transmitted in any suitable ways, and the present disclosure does not limit this aspect.

In this way, the first network device 110 may be aware that the terminal device 130 is in a state of the simultaneous connections of multi-USIM, and thus may not perform a reconfiguration of the terminal device 130 which requires higher capabilities of the terminal device 130.

In some embodiments, the terminal device 130 may determine 330 whether a connection with the second network device 120 is released. If determining that the connection with the second network device 120 is released, the terminal device 130 may transmit 340, to the first network device 110, a second indication indicating the releasing of the connection with the second network device 120. That is, the terminal device 130 may inform the first network device 110 upon leaving the state of the simultaneous connections.

In this way, the first network device 110 may be aware that the terminal device 130 exits a state of the simultaneous connections of multi-USIM, and thus may perform a reconfiguration of the terminal device 130 which requires higher capabilities of the terminal device 130.

Some example implementation for the indication of the simultaneous connections will be described in details in connection with Embodiments 1-4.

### Embodiment 1

In this embodiment, as the first indication, the terminal device 130 may transmit, to the first network device 110, first information indicating a restriction for capability of the terminal device 130 for the first USIM 131. In this way, the first network device 110 will not reconfigure the terminal device 130 with configuration exceeding the restriction for the capability of the terminal device 130. This will be described in detail with reference to FIG. 4.

FIG. 4 illustrates a schematic diagram illustrating another process 400 for communication according to embodiments of the present disclosure. For the purpose of discussion, the process 400 will be described with reference to FIG. 1. Assuming that the terminal device 130 has established simultaneous connections with the first network device 110 and the second network device 120. The process 400 may involve the terminal device 130 and the first network device 110 (also referred to as a network device here) as illustrated in FIG. 1.

As shown in FIG. 4, the terminal device 130 may determine 410 whether simultaneous connections are established with the first network device 110 and the second network device 120. The operation of the determination 410 is similar with the operation of the determination 310 as described in FIG. 3 and thus is not detailed here.

If determining that the simultaneous connections are established, the terminal device 130 may transmit 420, to the first network device 110, the first information indicating the restriction for capability of the terminal device 130 for the first USIM 131. It is to be understood that the first information may be transmitted in any suitable ways, and the present disclosure does not limit this aspect.

In some embodiments, the first information may comprise a set of allowed bands or band combinations for the first USIM 131. In some embodiments, the first information may comprise a set of bands or band combinations selected for the second USIM 132. In some embodiments, the first information may comprise the maximum number of cells for the first USIM 131, i.e., the maximum number of cells at the network of the first USIM 131. In some embodiments, the first information may comprise information regarding power coordination between the first USIM 131 and the second USIM 132. For example, the information regarding the power coordination may comprise the maximum power used by the terminal device 130 for the first USIM 131. Of course, the information regarding the power coordination may comprise any other suitable information. It is to be understood that the first information may also comprise any other suitable information, and the present disclosure does not limit this aspect.

The terminal device 130 may determine 430 whether a connection with the second network device 120 is released. If determining that the connection with the second network device 120 is released, the terminal device 130 may transmit 440, to the first network device 110, second information indicating cancel of the restriction. That is, the terminal device 130 may also indicate to the network of the first USIM 131 to release the capability restriction when the connection at the network of the second USIM 132 is released.

With the process described in connection with FIG. 4, the first network device 110 may not reconfigure the terminal device 130 with configuration exceeding the restriction for the capability of the terminal device 130.

### Embodiment 2

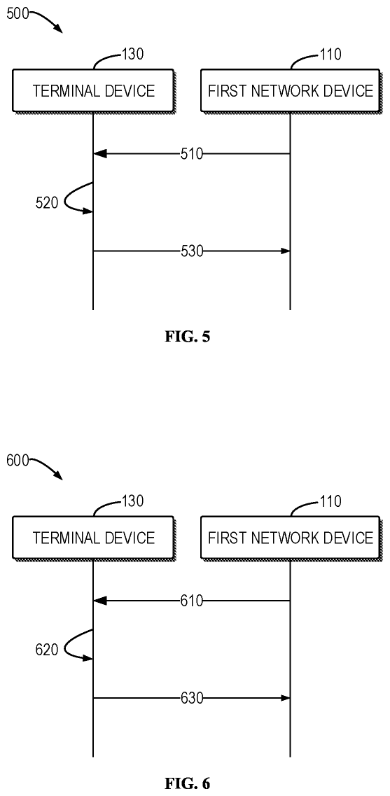

In this embodiment, as the first indication, the terminal device 130 may transmit, to the first network device 110, third information indicating that a cell for the first USIM 131 will experience interference from the simultaneous connections. In this way, the first network device 110 may avoid configuring the impacted cell to the terminal device 130. This will be described in detail with reference to FIG. 5.

FIG. 5 illustrates a schematic diagram illustrating another process 500 for communication according to embodiments of the present disclosure. For the purpose of discussion, the process 500 will be described with reference to FIG. 1. Assuming that the terminal device 130 has established simultaneous connections with the first network device 110 and the second network device 120. The process 500 may involve the terminal device 130 and the first network device 110 (also referred to as a network device here) as illustrated in FIG. 1.

As shown in FIG. 5, the first network device 110 may transmit 510, to the terminal device 130, a configuration indicating a transmission of third information. The third information indicates that a cell for the first USIM 131 will experience interference from the simultaneous connections. For example, the first network device 110 may configure the terminal device 130 to report the interference from the simultaneous connections in a measurement report.

In some embodiments, the first network device 110 may transmit the configuration in system information. It is to be understood that the configuration may be transmitted in any suitable ways, and the present disclosure does not limit this aspect.

The terminal device 130 may determine 520 whether simultaneous connections are established with the first network device 110 and the second network device 120. The operation of the determination 520 is similar with the operation of the determination 310 as described in FIG. 3 and thus is not detailed here.

If determining that the simultaneous connections are established, the terminal device 130 may transmit 530, to the first network device 110, the third information indicating that a cell for the first USIM 131 will experience the interference from the simultaneous connections. In some embodiments, the terminal device 130 may transmit the third information in a measurement report. For example, the terminal device 130 may indicate in the measurement report whether the neighboring cell will experience interference from the second USIM 132. It is to be understood that the third information may be transmitted in any suitable ways, and the present disclosure does not limit this aspect.

With the process described in connection with FIG. 5, the first network device 110 may avoid configuring the impacted cell to the terminal device 130.

### Embodiment 3

In this embodiment, as the first indication, the terminal device 130 may transmit, to the first network device 110, fourth information indicating that a cell for the first USIM 131 is experiencing an issue caused by the simultaneous connections. In this way, the first network device 110 may shift away the cell in which the terminal device 130 is experiencing interference from the second USIM 132, and may reconfigure the terminal device 130 with a proper configuration. This will be described in detail with reference to FIG. 6.

FIG. 6 illustrates a schematic diagram illustrating another process 600 for communication according to embodiments of the present disclosure. For the purpose of discussion, the process 600 will be described with reference to FIG. 1. Assuming that the terminal device 130 has established simultaneous connections with the first network device 110 and the second network device 120. The process 600 may involve the terminal device 130 and the first network device 110 (also referred to as a network device here) as illustrated in FIG. 1.

As shown in FIG. 6, the first network device 110 may transmit 610, to the terminal device 130, a configuration indicating a transmission of fourth information. The fourth information indicates that a cell for the first USIM 131 is experiencing an issue caused by the simultaneous connections. In some embodiments, the issue may comprise interference from the simultaneous connections. In some embodiments, the issue may comprise that capability of the terminal device 130 is exceeded. Of course, the issue may comprise any other related scenarios. It is to be understood that the configuration may be transmitted in any suitable ways, and the present disclosure does not limit this aspect.

The terminal device 130 may determine 620 whether simultaneous connections are established with the first network device 110 and the second network device 120. The operation of the determination 620 is similar with the operation of the determination 310 as described in FIG. 3 and thus is not detailed here.

If determining that the simultaneous connections are established, the terminal device 130 may transmit 630, to the first network device 110, the fourth information indicating that a cell for the first USIM 131 is experiencing an issue caused by the simultaneous connections. In some embodiments, the terminal device 130 may transmit the third information in a RRC message. For example, the RRC message may be UEAssistanceInformation message. As another example, the RRC message may be RRCReconfigurationComplete message. Of course, any other suitable RRC messages are also feasible. It is to be understood that the fourth information may be transmitted in any suitable ways, and the present disclosure does not limit this aspect.

In some embodiments, the fourth information may comprise a cause of the issue. For example, the cause of the issue may comprise at least one of the following: a set of serving cells which interference with the second USIM 132, an indication that a capability of the terminal device 130 is exceeded, or an indication that the number of cells for the first USIM 131 is exceeded. It should be noted that these merely are examples, and the cause of the issue may also comprise any other suitable items.

In some embodiments, the fourth information may comprise a suggested configuration. For example, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced. It is to be understood that these merely are examples, and the suggested configuration may also comprise any other suitable items.

It is also to be understood that the fourth information may also comprise any other suitable information, and the present disclosure does not limit this aspect.

With the process described in connection with FIG. 6, the first network device 110 may shift away the cell in which the terminal device 130 is experiencing interference from the second USIM 132, and may reconfigure the terminal device 130 with a proper configuration.

### Embodiment 4

In this embodiment, if the terminal device 130 detects that a configuration in RRCReconfiguration message from the network of the first USIM 131 leads to an issue at the network of the second USIM 132, the terminal device 130 may not apply the RRCReconfiguration message and reject the reconfiguration. In some embodiments, the issue may comprise interference from the simultaneous connections. In some embodiments, the issue may comprise that capability of the terminal device 130 is exceeded. Of course, the issue may comprise any other related scenarios.

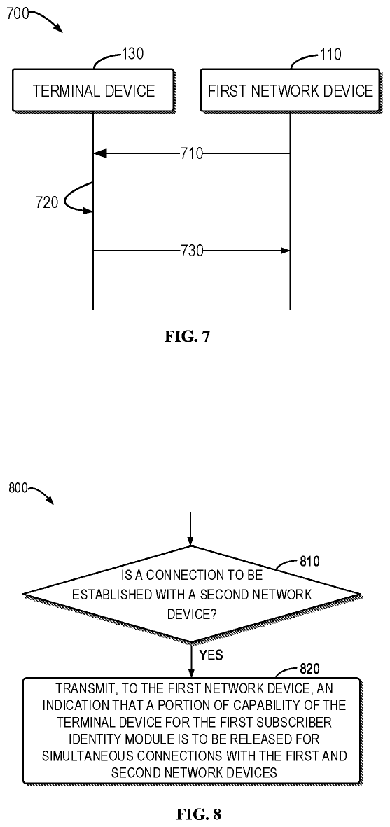

The details will be described with reference to FIG. 7. FIG. 7 illustrates a schematic diagram illustrating another process 700 for communication according to embodiments of the present disclosure. For the purpose of discussion, the process 700 will be described with reference to FIG. 1. Assuming that the terminal device 130 has established simultaneous connections with the first network device 110 and the second network device 120. The process 700 may involve the terminal device 130 and the first network device 110 (also referred to as a network device here) as illustrated in FIG. 1.

As shown in FIG. 7, the first network device 110 may transmit 710, to the terminal device 130, a first message for RRC reconfiguration. The first message comprises a configuration to be applied for the terminal device 130.

The terminal device 130 may determine 720 whether the configuration in the first message is applicable for the simultaneous connections. In other words, the terminal device 130 may determine whether the configuration will cause an issue associated with the simultaneous connections. For example, the terminal device 130 may determine whether the configuration will cause interference with the second USIM 132. In some embodiments, the terminal device 130 may determine whether the configuration will cause lack of capability of the terminal device 130.

If determining that the configuration in the first message is inapplicable for the simultaneous connections, the terminal device 130 may transmit 730, to the first network device 110, a second message for rejecting the RRC reconfiguration. For example, if the terminal device 130 determines that the configuration will cause interference with the second USIM 132, the terminal device 130 may determine that the configuration in the first message is inapplicable for the simultaneous connections. As another example, if the terminal device 130 determines that the configuration will cause lack of capability of the terminal device 130, the terminal device 130 may determine that the configuration in the first message is inapplicable for the simultaneous connections.

In some embodiments, the second message may comprise a cause for rejecting the RRC reconfiguration. For example, the cause may comprise at least one of the following: a set of serving cells which interference with the second USIM 132, an indication that a capability of the terminal device 130 is exceeded, or an indication that the number of cells for the first USIM 131 is exceeded. It should be noted that these merely are examples, and the cause of the issue may also comprise any other suitable items.

In some embodiments, the second message may comprise a suggested configuration. For example, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced. It is to be understood that these merely are examples, and the suggested configuration may also comprise any other suitable items.

It is also to be understood that the second message may also comprise any other suitable information, and the present disclosure does not limit this aspect.

With the process described in connection with FIG. 7, the RRC reconfiguration which will cause an issue associated with the simultaneous connections will not be applied by the terminal device 130.

It should be noted that actions shown in FIGS. 2 to 7 are not always necessary for implementing embodiments of the present disclosure, and more or less actions may be adapted as needed. Corresponding to the processes described in FIGS. 2 to 7, embodiments of the present disclosure provide methods of communication implemented at a terminal device and at a network device. These methods will be described below with reference to FIGS. 8 to 11.

### Example Implementation of Methods

FIG. 8 illustrates an example method 800 of communication implemented at a terminal device in accordance with some embodiments of the present disclosure. For example, the method 800 may be performed at the terminal device 130 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard. Assuming that the terminal device 130 is in a connected state with the first network device 110, and is in an idle or inactive state with the second network device 120.

As shown in FIG. 8, at block 810, the terminal device 130 determines whether a connection is to be established with the second network device 120. The first network device 110 is associated with the first USIM 131 of the terminal device 130 and the second network device 120 is associated with the second USIM 132 of the terminal device 130.

If the connection is to be established with the second network device 120, at block 820, the terminal device 130 transmits, to the first network device 110, an indication that a portion of capability of the terminal device 130 for the first USIM 131 is to be released for simultaneous connections with the first and second network devices 110 and 120.

In some embodiments, the terminal device 130 may start a timer upon the transmission of the indication. In some embodiments, the terminal device 130 may be forbidden to transmit a further indication to the first network device 110 for the simultaneous connections during running of the timer.

In some embodiments, the terminal device 130 may release the portion of the capability of the terminal device 130 if the timer is expired and no response for the releasing is received from the first network device 110. In some alternative embodiments, the terminal device 130 may go to an idle state if the timer is expired and no response for the releasing is received from the first network device 110.

In some embodiments, the terminal device 130 may transmit the indication by transmitting information indicating at least one of the following: a suggested configuration, a cause of the releasing being for the simultaneous connections, a preferred RRC state at the first network device 110, or an expected time length for the releasing. In some embodiments, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced. Of course, the suggested configuration may also comprise any other suitable information. It is to be understood that the indication may also comprise any other suitable information.

In some embodiments, the terminal device 130 may receive, from the first network device 110, a configuration indicating the transmission of the indication.

With the method of FIG. 8, capability coordination may be achieved for simultaneous connections of multi-USIM.

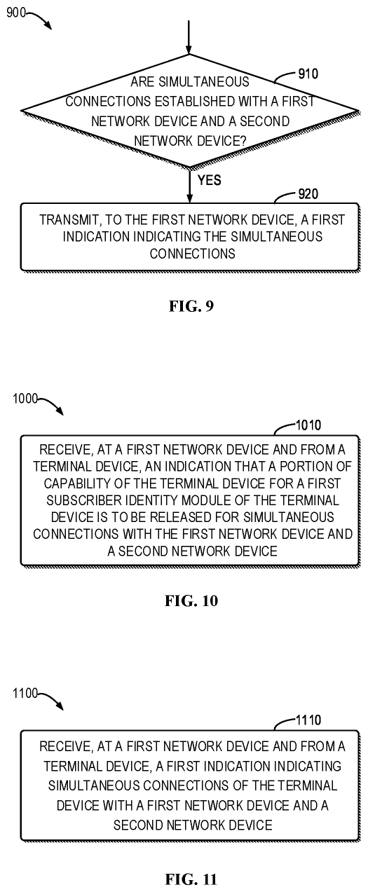

FIG. 9 illustrates another example method 900 of communication implemented at a terminal device in accordance with some embodiments of the present disclosure. For example, the method 900 may be performed at the terminal device 130 as shown in FIG. 1. For the purpose of discussion, in the following, the method 900 will be described with reference to FIG. 1. For convenience, the following description is given by taking the first network device 110 as an example of a network device. It is to be understood that the method 900 may also be performed between the terminal device 130 and the second network device 120 as shown in FIG. 1. It is to be understood that the method 900 may include additional blocks not shown and/or may omit some blocks as shown, and the scope of the present disclosure is not limited in this regard.

As shown in FIG. 9, at block 910, the terminal device 130 determines whether simultaneous connections are established with the first network device 110 and the second network device 120. The first network device 110 is associated with the first USIM 131 of the terminal device 130 and the second network device 120 is associated with the second USIM 132 of the terminal device 130.

If the simultaneous connections are established, at block 920, the terminal device 130 transmits, to the first network device 110, a first indication indicating the simultaneous connections. In this way, the first network device 110 will not reconfigure the terminal device 130 with configuration exceeding the restriction for the capability of the terminal device 130.

In some embodiments, if a connection with the second network device 120 is released, the terminal device 120 may transmits, to the first network device 110, a second indication indicating the releasing of the connection with the second network device 120. In this way, the first network device 110 may be aware that the terminal device 130 exits a state of the simultaneous connections of multi-USIM, and thus may perform a reconfiguration of the terminal device 130 which requires higher capabilities of the terminal device 130.

In some embodiments, the terminal device 130 may transmit the first indication by transmitting, to the first network device 110, first information indicating a restriction for capability of the terminal device 130 for the first USIM 131. In some embodiments, the first information may comprise at least one of the following: a set of allowed bands or band combinations for the first USIM 131, a set of bands or band combinations selected for the second USIM 132, the maximum number of cells for the first USIM 131, or information regarding power coordination between the first USIM 131 and the second USIM 132. In some embodiments, the information regarding the power coordination may comprise the maximum power used by the terminal device 130 for the first USIM 131. Of course, the information regarding the power coordination may also comprise any other suitable information. It is to be understood that the first information may also comprise any other suitable information.

In some embodiments, if a connection with the second network device is released, the terminal device 130 may transmit, to the first network device 110, second information indicating cancel of the restriction. In this way, the first network device 110 may not reconfigure the terminal device 130 with configuration exceeding the restriction for the capability of the terminal device 130.

In some embodiments, the terminal device 130 may transmit the first indication by transmitting, to the first network device 110, third information indicating that a cell for the first USIM 131 will experience interference from the simultaneous connections. In some embodiments, the terminal device 130 may transmit the third information in a measurement report. In some embodiments, the terminal device 130 may receive, from the first network device 110, a configuration indicating the transmission of the third information. In this way, the first network device 110 may avoid configuring the impacted cell to the terminal device 130.

In some embodiments, the terminal device 130 may transmit the first indication by transmitting, to the first network device 110, fourth information indicating that a cell for the first USIM 131 is experiencing an issue caused by the simultaneous connections. In some embodiments, the terminal device 130 may transmit, to the first network device 110, the fourth information in a RRC message. In some embodiments, the terminal device 130 may receive, from the first network device 110, a configuration indicating the transmission of the fourth information.

In some embodiments, the fourth information may comprise at least one of the following: a cause of the issue, or a suggested configuration. In some embodiments, the cause of the issue comprises at least one of the following: a set of serving cells which interference with the second USIM 132, an indication that a capability of the terminal device 130 is exceeded, or an indication that the number of cells for the first USIM 131 is exceeded. Of course, the cause may adopt any other suitable forms. In some embodiments, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced. It should be noted that the fourth information may also comprise any other suitable information. In this way, the first network device 110 may shift away the cell in which the terminal device 130 is experiencing interference from the second USIM 132, and may reconfigure the terminal device 130 with a proper configuration.

In some embodiments, the terminal device 130 may transmit the first indication by determining whether a configuration in a first message for RRC reconfiguration received from the first network device 110 is applicable for the simultaneous connections: and transmitting, to the first network device 110, a second message for rejecting the RRC reconfiguration if the configuration is inapplicable for the simultaneous connections.

In some embodiments, the second message may comprise at least one of the following: a cause for rejecting the RRC reconfiguration, or a suggested configuration. In some embodiments, the cause for rejecting the RRC reconfiguration comprises at least one of the following: a set of serving cells which interference with the second USIM 132, an indication that a capability of the terminal device 130 is exceeded, or an indication that the number of cells for the first USIM 131 is exceeded. Of course, the cause may adopt any other suitable forms. In some embodiments, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced. It should be noted that the second message may also comprise any other suitable information. In this way, the RRC reconfiguration which will cause an issue associated with the simultaneous connections will not be applied by the terminal device 130.

FIG. 10 illustrates an example method 1000 of communication implemented at a network device in accordance with some embodiments of the present disclosure. For example, the method 1000 may be performed at the first network device 110 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard. Assuming that the terminal device 130 is in a connected state with the first network device 110, and is in an idle or inactive state with the second network device 120.

As shown in FIG. 10, at block 1010, the first network device 110 receives, from the terminal device 130, an indication that a portion of capability of the terminal device 130 for the first USIM 131 of the terminal device 130 is to be released for simultaneous connections with the first network device 110 and the second network device 120. The first network device 110 is associated with the first USIM 131 and the second network device 120 is associated with the second USIM 132 of the terminal device 130.

In some embodiments, the indication may comprise information indicating at least one of the following: a suggested configuration, a cause of the releasing being for the simultaneous connections, a preferred RRC state at the first network device 110, or an expected time length for the releasing. In some embodiments, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced.

In some embodiments, the first network device 110 may transmit, to the terminal device 130, a configuration indicating the transmission of the indication.

With the method of FIG. 10, the first network device 110 may perform capability coordination for simultaneous connections of multi-USIM.

FIG. 11 illustrates another example method 1100 of communication implemented at a network device in accordance with some embodiments of the present disclosure. For the purpose of discussion, in the following, the method 1100 will be described with reference to FIG. 1. For example, the method 1100 may be performed at the first network device 11 as shown in FIG. 1. It is to be understood that the method 1100 may also be performed at the second network device 120 as shown in FIG. 1. For convenience, the following description is given by taking the first network device 110 as an example of the network device. It is to be understood that the method 1100 may include additional blocks not shown and/or may omit some blocks as shown, and the scope of the present disclosure is not limited in this regard.

As shown in FIG. 11, at block 1110, the first network device 110 receives, from the terminal device 130, a first indication indicating simultaneous connections of the terminal device 130 with the first network device 110 and the second network device 120. The first network device 110 is associated with the first USIM 131 of the terminal device 130 and the second network device 120 is associated with the second USIM 132 of the terminal device 130.

In some embodiments, the first network device 110 may receive, from the terminal device 130, a second indication indicating a release of a connection of the terminal device 130 with the second network device 120.

In some embodiments, the first network device 110 may receive the first indication by receiving, from the terminal device 130, first information indicating a restriction for capability of the terminal device for the first subscriber identity module.

In some embodiments, the first information may comprise at least one of the following: a set of allowed bands or band combinations for the first USIM 131, a set of bands or band combinations selected for the second USIM 132, the maximum number of cells for the first USIM 131, or information regarding power coordination between the first USIM 131 and the second USIM 132. In some embodiments, the information regarding the power coordination may comprise the maximum power used by the terminal device 130 for the first USIM 131.

In some embodiments, the first network device 110 may transmit, to the terminal device 130, a configuration indicating the transmission of the third information. In some embodiments, the first network device 110 may receive, from the terminal device 130, second information indicating cancel of the restriction.

In some embodiments, the first network device 110 may receive the first indication by receiving, from the terminal device 130, third information indicating that a cell for the first USIM 131 will experience an issue caused by the simultaneous connections. In some embodiments, the first network device 110 may receive the third information in a measurement report.

In some embodiments, the first network device 110 may receive the first indication by receiving, from the terminal device 130, fourth information indicating that a cell for the first USIM 131 is experiencing an issue caused by the simultaneous connections. In some embodiments, the first network device 110 may receive the fourth information in a RRC message.

In some embodiments, the first network device 110 may transmit, to the terminal device 130, a configuration indicating the transmission of the fourth information.

In some embodiments, the fourth information may comprise at least one of the following: a cause of the issue, or a suggested configuration. In some embodiments, the cause of the issue comprises at least one of the following: a set of serving cells which interference with the second USIM 132, an indication that a capability of the terminal device 130 is exceeded, or an indication that the number of cells for the first USIM 131 is exceeded. In some embodiments, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced.

In some embodiments, the first network device 110 may transmit, to the terminal device 130, a first message for RRC reconfiguration, and receive a second message for rejecting the RRC reconfiguration. The second message is transmitted by the terminal device 130 when a configuration in the first message is inapplicable for the simultaneous connections.

In some embodiments, the second message may comprise at least one of the following: a cause for rejecting the RRC reconfiguration, or a suggested configuration. In some embodiments, the cause for rejecting the RRC reconfiguration comprises at least one of the following: a set of serving cells which interference with the second USIM 132, an indication that a capability of the terminal device 130 is exceeded, or an indication that the number of cells for the first USIM 131 is exceeded. In some embodiments, the suggested configuration may comprise at least one of the following: a request for deactivating a SCG of the terminal device 130, a request for releasing a SCG of the terminal device 130, a set of Scells to be deactivated, a set of Scells to be released, or the maximum MIMO layer to be reduced.

With the method of FIG. 11, the first network device 110 may be aware that the terminal device 130 is in a state of the simultaneous connections of multi-USIM, and thus may not perform a reconfiguration of the terminal device 130 which requires higher capabilities of the terminal device 130.

The operations of steps in methods 200-1100 are similar with that described in connection with FIGS. 2 and 11, and thus other details are not repeated here.

### Example Implementation of Device

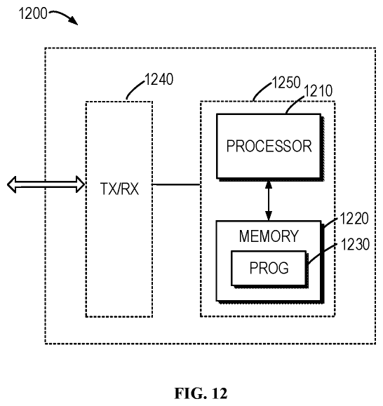

FIG. 12 is a simplified block diagram of a device 1200 that is suitable for implementing embodiments of the present disclosure. The device 1200 can be considered as a further example implementation of the first network device 110, the terminal device 130, or the second network device 120 as shown in FIG. 1. Accordingly, the device 1200 can be implemented at or as at least a part of the first network device 110, the terminal device 130, or the second network device 120.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1230 is assumed to include program instructions that, when executed by the associated processor 1210, enable the device 1200 to operate in accordance with the embodiments of the present disclosure, as discussed herein with reference to FIGS. 1 to 11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

In some embodiments, a terminal device comprises circuitry configured to: determine, in a connected state with a first network device, whether a connection is to be established with a second network device, the first network device being associated with a first subscriber identity module of the terminal device and the second network device being associated with a second subscriber identity module of the terminal device; and in accordance with a determination that the connection is to be established with the second network device, transmit, to the first network device, an indication that a portion of capability of the terminal device for the first subscriber identity module is to be released for simultaneous connections with the first and second network devices.

In some embodiments, the circuitry may be further configured to start a timer upon the transmission of the indication. In some embodiments, the terminal device may be forbidden to transmit a further indication to the first network device for the simultaneous connections during running of the timer. In some embodiments, the circuitry may be further configured to: in accordance with a determination that the timer is expired and no response for the releasing is received from the first network device, release the portion of the capability of the terminal device; or go to an idle state.

In some embodiments, the circuitry may be configured to transmit the indication by transmitting information indicating at least one of the following: a suggested configuration, a cause of the releasing being for the simultaneous connections, a preferred radio resource control state at the first network device, or an expected time length for the releasing. In some embodiments, the suggested configuration may comprise at least one of the following: a request for deactivating a secondary cell group of the terminal device, a request for releasing a secondary cell group of the terminal device, a set of secondary cells to be deactivated, a set of secondary cells to be released, or the maximum multi-input multi-output layer to be reduced.

In some embodiments, the circuitry may be further configured to: receive, from the first network device, a configuration indicating the transmission of the indication.

In some embodiments, a terminal device comprises circuitry configured to: determine whether simultaneous connections are established with a first network device and a second network device, the first network device being associated with a first subscriber identity module of the terminal device and the second network device being associated with a second subscriber identity module of the terminal device; and in accordance with a determination that the simultaneous connections are established, transmit, to the first network device, a first indication indicating the simultaneous connections.

In some embodiments, the circuitry may be further configured to: in accordance with a determination that a connection with the second network device is released, transmit, to the first network device, a second indication indicating the releasing of the connection with the second network device.

In some embodiments, the circuitry may be configured to transmit the first indication by transmitting, to the first network device, first information indicating a restriction for capability of the terminal device for the first subscriber identity module.

In some embodiments, the circuitry may be configured to transmit the first information by transmitting at least one of the following: a set of allowed bands or band combinations for the first subscriber identity module, a set of bands or band combinations selected for the second subscriber identity module, the maximum number of cells for the first subscriber identity module, or information regarding power coordination between the first subscriber identity module and the second subscriber identity module. In some embodiments, the information regarding the power coordination may comprise the maximum power used by the terminal device for the first subscriber identity module.

In some embodiments, the circuitry may be further configured to: in accordance with a determination that a connection with the second network device is released, transmit, to the first network device, second information indicating cancel of the restriction.

In some embodiments, the circuitry may be configured to transmit the first indication by transmitting, to the first network device, third information indicating that a cell for the first subscriber identity module will experience interference from the simultaneous connections. In some embodiments, the circuitry may be configured to transmit the third information by transmitting, to the first network device, the third information in a measurement report.

In some embodiments, the circuitry may be further configured to: receive, from the first network device, a configuration indicating the transmission of the third information.

In some embodiments, the circuitry may be configured to transmit the first indication by transmitting, to the first network device, fourth information indicating that a cell for the first subscriber identity module is experiencing an issue caused by the simultaneous connections. In some embodiments, the circuitry may be configured to transmit the fourth information by transmitting, to the first network device, the fourth information in a radio resource control message.

In some embodiments, the circuitry may be further configured to receive, from the first network device, a configuration indicating the transmission of the fourth information.

In some embodiments, the circuitry may be configured to transmit the fourth information by transmitting at least one of the following: a cause of the issue, or a suggested configuration.

In some embodiments, the circuitry may be configured to transmit the first indication by determining whether a configuration in a first message for radio resource control reconfiguration received from the first network device is applicable for the simultaneous connections; and in accordance with a determination that the configuration is inapplicable for the simultaneous connections, transmitting, to the first network device, a second message for rejecting the radio resource control reconfiguration.

In some embodiments, the circuitry may be configured to transmit the second message by transmitting at least one of the following: a cause for rejecting the radio resource control reconfiguration, or a suggested configuration.

In some embodiments, the cause for the issue or the cause for rejecting the radio resource control reconfiguration may comprise at least one of the following: a set of serving cells which interference with the second subscriber identity module, an indication that a capability of the terminal device is exceeded, or an indication that the number of cells for the first subscriber identity module is exceeded. In some embodiments, the suggested configuration may comprise at least one of the following: a request for deactivating a secondary cell group of the terminal device, a request for releasing a secondary cell group of the terminal device, a set of secondary cells to be deactivated, a set of secondary cells to be released, or the maximum multi-input multi-output layer to be reduced.

In some embodiments, a first network device comprises circuitry configured to: receive, from a terminal device, an indication that a portion of capability of the terminal device for a first subscriber identity module of the terminal device is to be released for simultaneous connections with the first network device and a second network device, the first network device being associated with the first subscriber identity module of the terminal device and the second network device being associated with a second subscriber identity module of the terminal device.

In some embodiments, the circuitry may be configured to receive the indication by receiving information indicating at least one of the following: a suggested configuration, a cause of the releasing being for the simultaneous connections, a preferred radio resource control state at the first network device, or an expected time length for the releasing. In some embodiments, the suggested configuration may comprise at least one of the following: a request for deactivating a secondary cell group of the terminal device, a request for releasing a secondary cell group of the terminal device, a set of secondary cells to be deactivated, a set of secondary cells to be released, or the maximum multi-input multi-output layer to be reduced.

In some embodiments, the circuitry may be further configured to transmit, to the terminal device, a configuration indicating the transmission of the indication.

In some embodiments, a first network device comprises circuitry configured to: receive, from a terminal device, a first indication indicating simultaneous connections of the terminal device with a first network device and a second network device, the first network device being associated with a first subscriber identity module of the terminal device and the second network device being associated with a second subscriber identity module of the terminal device.

In some embodiments, the circuitry may be further configured to receive, from the terminal device, a second indication indicating a release of a connection of the terminal device with the second network device.

In some embodiments, the circuitry may be configured to receive the first indication by receiving, from the terminal device, first information indicating a restriction for capability of the terminal device for the first subscriber identity module.

In some embodiments, the circuitry may be configured to receive the first information by receiving at least one of the following: a set of allowed bands or band combinations for the first subscriber identity module, a set of bands or band combinations selected for the second subscriber identity module, the maximum number of cells for the first subscriber identity module, or information regarding power coordination between the first subscriber identity module and the second subscriber identity module. In some embodiments, the information regarding the power coordination may comprise the maximum power used by the terminal device for the first subscriber identity module.

In some embodiments, the circuitry may be further configured to receive, from the terminal device, second information indicating cancel of the restriction.

In some embodiments, the circuitry may be configured to receive the first indication by receiving, from the terminal device, third information indicating that a cell for the first subscriber identity module will experience an issue caused by the simultaneous connections.

In some embodiments, the circuitry may be configured to receive the third information by receiving, from the terminal device, the third information in a measurement report.

In some embodiments, the circuitry may be further configured to transmit, to the terminal device, a configuration indicating the transmission of the third information.

In some embodiments, the circuitry may be configured to receive the first information by receiving, from the terminal device, fourth information indicating that a cell for the first subscriber identity module is experiencing an issue caused by the simultaneous connections. In some embodiments, the circuitry may be configured to receive the fourth information by receiving, from the terminal device, the fourth information in a radio resource control message. In some embodiments, the circuitry may be further configured to transmit, to the terminal device, a configuration indicating the transmission of the fourth information.

In some embodiments, the circuitry may be configured to receive the fourth information by receiving at least one of the following: a cause of the issue, or a suggested configuration.

In some embodiments, the circuitry may be further configured to: transmit, to the terminal device, a first message for radio resource control reconfiguration; and receive a second message for rejecting the radio resource control reconfiguration, the second message being transmitted by the terminal device in accordance with a determination that a configuration in the first message is inapplicable for the simultaneous connections.

In some embodiments, the circuitry may be configured to receive the second message by receiving at least one of the following: a cause for rejecting the radio resource control reconfiguration, or a suggested configuration.

In some embodiments, the cause of the issue or the cause for rejecting the radio resource control reconfiguration may comprise at least one of the following: a set of serving cells which interference with the second subscriber identity module, an indication that a capability of the terminal device is exceeded, or an indication that the number of cells for the first subscriber identity module is exceeded. In some embodiments, the suggested configuration may comprise at least one of the following: a request for deactivating a secondary cell group of the terminal device, a request for releasing a secondary cell group of the terminal device, a set of secondary cells to be deactivated, a set of secondary cells to be released, or the maximum multi-input multi-output layer to be reduced.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1.-49. (canceled).

50. A method of terminal device, comprising:
communicating with a first network associated with a first Universal Subscriber Identity Module (USIM), and a second network associated with a second USIM, and
transmitting, to the first network device, a message including a first configuration of temporary capability restriction of the terminal device in connected state with the first network device, and
wherein the terminal device is Multi-USIM (MUSIM) device, and
wherein the terminal device includes the first USIM and second USIM.

51. The method of claim 50, further comprising:
transmitting the message in a case where the terminal device starts connection to the second network device.

52. The method of claim 50, further comprising:
receiving, from the first network device, a second configuration including an information to transmit, to the first network device, the first configuration.

53. The method of claim 50, wherein the first configuration comprises at least one of the following:
a request for deactivating a secondary cell group of the terminal device,
a request for releasing a secondary cell group of the terminal device,
a set of secondary cells to be deactivated,
a set of secondary cells to be released, or
the number of multi-input multi-output (MIMO) layer.

54. The method of claim 50, further comprising:
receiving, from the first network device, the first configuration using UEAssistanceInformation message.

55. The method of claim 50, further comprising:
starting a timer on the transmission of the message including the first configuration.

56. The method of claim 55, wherein the terminal device transmits the message including the first configuration and starts the timer in a case where the timer is not running.

57. The method of claim 55, further comprising:
applying a temporary capability restriction of the terminal device in a case where the timer is expired.

58. The terminal device comprising:
a memory configured to store instructions; and
a processor configured to execute the instructions to
communicate with a first network associated with a first Universal Subscriber Identity Module (USIM), and a second network associated with a second USIM, and
transmit, to the first network device, a message including a first configuration of temporary capability restriction of the terminal device in connected state with the first network device, and
wherein the terminal device is Multi-USIM (MUSIM) device, and
wherein the terminal device includes the first USIM and the second USIM.

59. The terminal device of claim 58,
wherein the terminal device transmits the message in a case where the terminal device starts connection to the second network device.

60. The terminal device of claim 58,
wherein the terminal device receives, from the first network device, a second configuration including an information to transmit, to the first network device, the first configuration.

61. The terminal device of claim 58, wherein the first configuration comprises at least one of the following:
a request for deactivating a secondary cell group of the terminal device,
a request for releasing a secondary cell group of the terminal device,
a set of secondary cells to be deactivated,
a set of secondary cells to be released, or
the number of multi-input multi-output (MIMO) layer.

62. The terminal device of claim 58, wherein:
the terminal device receives, from the first network device, the first configuration using UEAssistanceInformation message.

63. The terminal device of claim 58, wherein:
the terminal device starts a timer on the transmission of the message including the first configuration.

64. The terminal device of claim 63, wherein:
the terminal device transmits the message including the first configuration and starts the timer in a case where the timer is not running.

65. The terminal device of claim 63, wherein:
the terminal device applies a temporary capability restriction of the terminal device in a case where the timer is expired.

66. A method of network device, comprising:
communicating with a terminal device associated with a first Universal Subscriber Identity Module (USIM),
receiving, from the terminal device, a message including a first configuration of temporary capability restriction of the terminal device in connected state with the first network device, and
wherein the terminal device is Multi-USIM (MUSIM) device, and
wherein the terminal device includes the first USIM and a second USIM.

67. A network device, comprising:
a memory configured to store instructions; and
a processor configured to execute the instructions to
communicate with a terminal device associated with a first Universal Subscriber Identity Module (USIM),
receive, from the terminal device, a message including a first configuration of temporary capability restriction of the terminal device in connected state with the first network device, and
wherein the terminal device is Multi-USIM (MUSIM) device, and wherein the terminal device includes the first USIM and a second USIM.
